(19) United States
(12) Patent Application Publication
(10) Pub. No.: US 2008/0068261 A1
(43) Pub. Date: Mar. 20, 2008

(54) Exchanging Condition Information Between A GPS Receiver And A Display Unit Device

(75) Inventor: Erno Hempel, Munchen (DE)

Correspondence Address: FISH & RICHARDSON P.C., PO BOX 1022, MINNEAPOLIS, MN, 55440-1022, US

(73) Assignee: JENTRO TECHNOLOGIES GMBH, Munich (DE)

(21) Appl. No.: 11/609,200

(22) Filed: Dec. 11, 2006

Related U.S. Application Data
(63) Continuation-in-part of application No. 11/506,177, filed on Aug. 16, 2006.

(51) Int. Cl. G01S 5/14

(52) U.S. Cl. 342/357.06

(57) ABSTRACT

Apparatus and methods that enhance the usability of GPS (global positioning system) receivers. In one aspect, methods indicate a battery low condition of a GPS receiver to a connected accessory device. In another aspect, methods adjust light intensity of, e.g., LED's of a GPS receiver connected to an accessory device in response to information provided by the accessory device.

### CROSS-REFERENCE TO RELATED APPLICATIONS

This application is a continuation-in-part application of, and claims priority to, U.S. patent application Ser. No. 11/506,177, entitled “Accelerated Time To First Fix for Satellite-Based Positioning Systems”, to inventor Emo Hempel, which was filed on Aug. 16, 2006. The disclosure of the foregoing application is incorporated here by reference in its entirety.

### BACKGROUND

This specification relates to mobile terminals using satellite-based positioning.

Different satellite-based systems exist for positioning and localization, navigation and similar tasks related to the geographic position of a receiver. One of these systems is the NAVSTAR-GPS (Navigational Satellite Timing and Ranging—Global Positioning System) operated by the United States Department of Defense. This system is usually called GPS, and will be referred to under this name throughout this document.

Other satellite positioning systems include, e.g., Transit (the predecessor of the GPS), GLONASS, a Russian counterpart, EutelTracs, a European mobile fleet communication system, and Galileo, a project commissioned by the European Union, as well as other systems.

The operation of satellite positioning systems will be described in reference to GPS, for illustration.

Originally, GPS was designed for positioning and navigation in the military (in weapons systems, warships, aircraft). Today, it is also used in commercial applications, e.g., in the merchant marine, aviation, vehicle-installed navigation systems, outdoor applications, and surveying.

GPS is based on satellites that continuously transmit signals, with the signal propagation delay being used by GPS receivers to determine their own position. Theoretically, the signals from three satellites are sufficient since they allow the exact position and altitude to be determined. In practice, however, most GPS receivers do not have a precise enough clock to correctly calculate the propagation delays. For that reason, the signal of at least a fourth satellite is generally required as well. It is advantageous if, from the receiver's viewpoint, the satellites are located in different compass directions.

GPS signals can also be used to determine the speed of the receiver. Due to the motion of the receiver relative to the satellite, a Doppler effect causes the signal to shift; and since the speed of the satellite is known, the speed of the receiver can be calculated accordingly.

In order for a GPS receiver to always be in contact with at least four satellites, a minimum total of 24 satellites in 6 orbits are used, orbiting the earth at an altitude of 20,200 km once every 12 hours. To avoid a loss when satellites break down, additional satellites were introduced into orbit, so that in 2005, 31 satellites were orbiting the earth. Each one of the 6 orbits contains at least four satellites. Each orbit has an inclination of 55° towards the equator, and is rotated around the axis of the earth by about 60° towards the neighboring orbits.

The satellites have two transmitters operating with spread-spectrum technology and transmitting on the GPS frequencies of 1.57542 GHz (so-called L1-frequency) and 1.2276 GHz (so-called L2-frequency). Preferably, the GPS signals are modulated to these carrier frequencies by phase modulation.

The accuracy of the positioning (about 0.5-5 m) can be increased by using Differential GPS (DGPS). Differential Global Positioning System (DGPS) is the name for procedures using multiple GPS-receivers for increased accuracy.

These characteristics make GPS technology interesting for use in conjunction with mobile phones, e.g., to offer location based services. However, problems can arise due to the time period required to initially determine position, because initialization requires specific data, which, unless already known, must be received or determined. The more those data required at the start of positioning are already known, the quicker the positioning can take place. Depending on the type of required information already stored, one can differentiate between a “hot start”, a “warm start”, or a “cold start”. For example, a “hot start” can occur when the almanac data are stored, the ephemerid data are less then 2 hours old, the receiving time has been determined with an accuracy of less than 5 minutes, and the own position is generally known. A “warm start” can occur when the almanac data are known, the time and location are approximately known, and the ephemerid data are not known at all. A “cold start” occurs when even fewer or no data at all are known or available. In this case, the time to determine the initial position, which is often called TTFF (“time to first fix”) may require 20 minutes or more. This type of situation may also occur when the stored data have been lost due to a power failure, if the GPS receiver was turned off for too long, and/or if the switched-off GPS was moved to a location very far from the original location.

Theoretically, the position of the receiver could be determined continuously, so that the actual data could basically continuously be updated; however, the power required for the satellite receiver would be too great for mobile applications. Furthermore, especially in closed rooms and urban areas, the satellite signals are so weak that they usually cannot be detected.

In view of these problems, A-GPS (assisted GPS) was developed. A-GPS combines the use of a satellite-based GPS system with the reception of so-called assistance information from stationary reference receiver units over a mobile wireless network, where the mobile wireless network transmits supporting data to the receiver.

In conventional GPS, the receiver has two tasks. It measures the arrival time of the signals and reads the data sent by the satellite, which include the parameters of the orbit and error corrections. In A-GPS, the satellite data are read by the stationary reference receivers that are installed at locations with a good view of the sky, so that the mobile receiver only needs to measure the arrival times, for which in comparison to conventional methods a receiving level of up to 30 dB less is sufficient. Also, for mobile phones, the general location is known from the cell ID associated with the mobile phone service. It is used to limit the searching range for the satellite signals (identity of the visible satellites, approximate time of arrival, Doppler-shift), and therefore to speed up the measurement.

Due to its high sensitivity, in some cases a positioning accuracy of a few meters can be achieved in cities and buildings as well. In doing so, the assistant information sent via the mobile phone network (e.g., a GSM network) lightens the load of the GPS receiver and shortens the TTFF significantly in comparison to conventional GPS systems due to the fact that the A-GPS server is continuously supplied with the most recent satellite positions and is sending the locally relevant data available within the mobile wireless networks. Another advantage is that positioning can often be performed even when the receiver, the cell phone or the PDA, can receive one GPS-satellite only.

Depending on the location at which the actual calculation of the position takes place, one can differentiate between a network-based and a terminal-based mode. In network-based A-GPS, the terminal transmits the measured arrival times (or distances) of the satellite or satellites, and a server in the network uses these data to calculate the position, which eventually is sent to the terminal or an application. In this case, assistant data are search area parameters only. In terminal-based mode, the terminal receives the satellite data and also calculates the position after the measurement.

Solutions within A-GPS for a shortening of the TTFF are currently being offered only to a few mobile wireless providers, and are available to the customers of the respective service provider only. Also, the countrywide use of reference receiver units is technically cumbersome and cost-intensive.

### SUMMARY

This specification describes technologies that introduce a simple and efficient method to reduce the TTFF of satellite data receivers, especially for cold starts.

This specification also describes technologies for an infrastructure and process for preloading GPS receivers with ephemerid data at startup if necessary.

This specification further describes simple and efficient technologies for enhancing handling and usability of GPS receivers.

In general, one aspect of the technologies include a base station with a communication device for a network with mobile terminals (for example, mobile devices that can communicate with other mobile devices or with a base station, over a mobile telephone or other wireless technology, including, for example, mobile telephones (e.g., cell phones or smartphones), personal digital assistants, in-car navigation systems, hand-held navigation devices, and so on) with receivers for the reception of satellite signals that can be used to determine the geographic position (i.e., the location, altitude, and optionally a moving direction and/or moving speed) of the receivers, and hence of the mobile terminals. The communication device is able to exchange data with the mobile terminals (unidirectional, bi-directional and/or multidirectional). The base station is designed to receive the information data supplied by one or multiple mobile terminals serving as reference units, and the base station is able to supply a mobile terminal functioning as a target unit with a positioning data set, and wherein the positioning data are based on one or multiple sets of information data designed in such fashion that the target unit is able to analyze the data is has received from the satellite based on the positioning data set.

The term “information data set” refers to those sets of data that are supplied by a reference unit. Such data sets contain information based on received satellite signals or derived from satellite data, which may include but are not limited to almanac data, orbital data of individual satellites, time reference tolerances, the IDs of received satellites, the arrival times of the satellite data at the reference unit, a time reference between the reference unit and the base station, and/or the geographic position of the receiver of the reference unit.

In contrast, the term “positioning data set” refers to a set of data supplied by or through the base station to the target units. The positioning data sets are based on one or multiple information data sets and contain data allowing the target unit to determine the initial position (time to first fix) faster than without these data.

Advantages of some implementations include that it is not necessary to set up a network of stationary reference stations throughout a state or a country, for example, since the mobile terminals of the users of a service may themselves be reference stations. This saves a large amount of costs for the supply and maintenance of such a network of reference stations. Furthermore, the service provider is not required anymore to negotiate with individual mobile wireless providers if, under which conditions, and how individual assistant data shall be utilized, which potentially are already available in the respective mobile wireless network. In addition, in areas with sufficient user density it is possible to include into positioning data highly accurate and/or highly up-to-date assistant data for a geographic area.

In some implementations, the base station will, depending on at least one criterion (e.g., local proximity), supply a target unit with information data either in unchanged form or in the form of positioning data, or the base station will process one or multiple information data sets depending on the at least one criterion and/or at least one other criterion. The base station provides the processed information data in the form of a positioning data set. The respective criteria are based on one or more of the following individual parameters:
Information data set containing raw data from the satellite signals,
Information data set containing specifically processed data from the satellite signals, e.g., in the reference unit,
geographic position of the antenna of the reference unit,
geographic location of the antenna of the target unit to which the positioning data set will be supplied,
Number of satellites, from which the reference unit has received satellite signals,
Identities of the individual satellites, from which the reference unit has received satellite signals,
reception quality of the satellite signals of individual satellites received by the reference unit,
age of the received information data set,
type of reference unit, and/or
type of the antenna of the reference unit.

Advantages of such embodiments include the fact that data traffic can be kept low, and that mobile terminals may also be devices with low CPU power and/or small memory space. The data sets stored on the base station can be stored in a type of modular system, whose components are continuously updated, so that the disadvantage of the mobile reference stations can be reduced or eliminated, where afterward the receivers of the mobile terminals, depending on location and environmental conditions, may be able to receive signals from specific satellites only, or the reception of the signals from some satellites is weak or corrupted by reflections. Accordingly, and depending on specific known parameters, the base station can generate customized sets of data for different target units and keep the data sets to be transmitted small.

Furthermore, the geographic location of the receiver of the target unit can be determined by the target unit from previously received data, which the target unit will then forward to the base station, especially based on data allowing a match based on the following options:
Mapping to a geographic location based on one or multiple IDs being transmitted and/or exchanged between a target unit and the base station via a wireless, telephone, or data connection, e.g., the “Mobile Country Code”, and/or the “Mobile Network Code” and/or the “Location Area Code”,
Mapping to a geographic location based on service provider-specific information, e.g., the cell ID,
Mapping to a geographic location based on a target address or target coordinates entered previously,
Mapping to a geographic location based on position or location information entered by the user, and/or
Mapping to a geographic location based on the reception of signals that can be matched to geographic location, e.g., ID's of local wireless networks, e.g., WLAN (wireless local area network), Bluetooth, Near-Field, RFID and/or RDS ID's.

In this way it is possible to at least determine the approximate location of a mobile terminal, so that the data selected and/or processed for this mobile terminal can be optimally selected for the geographic location, so that with the help of these data the mobile terminal is able to determine the initial position even faster. This provides solutions without requiring information that may not be available from the individual mobile wireless providers.

In some implementations, a mobile terminal is notified by a base station if and/or under what conditions the mobile terminal shall serve as reference unit and supply an information data set. The conditions can be selected depending on satellite data (and are optionally already stored on the base station), and especially the number of satellites received by the receiver of the target unit and/or the reception quality with which satellites are received by the receiver. It is advantageous if the mobile terminal being notified that it needs to supply information data is at the same time a target unit, so that the notification occurs at the same time the positioning data are being supplied.

This has the advantage that data can be requested especially for a specific area when sufficient data are not available, and based on the location of the target unit it can be assumed that the data that are already stored in the base station can be supplied, amended or updated by the target unit with the help of additional data. This maintains on one hand the database of the base station, and on the other hand prevents unnecessary data traffic (and thus costs and energy) being generated by the mobile terminal.

Some implementations include a mobile terminal (e.g., a mobile phone or a smartphone, i.e., a voice-centric mobile phone with information processing capability) with a receiver for the reception of satellite signals, which can be used to determine the geographic position of the mobile terminal, and communication devices for the transmission of data, so that the mobile terminal can be designated as a reference unit able to supply an information data set via its communication device, which at a minimum contains satellite data or data derived from satellite data. Based on the information data set—with the addition of other information data sets of other reference units—a positioning data set can be generated that enables a target unit to analyze the data it receives from satellites with the help of the positioning data.

Such mobile terminal in some implementations is able to serve as a target unit, meaning that it is able to receive a positioning data set via its communication device being suitable for the target unit to more quickly determine its own geographic position.

This has the advantage that the position will be determined much faster, especially with a shorter TTFF if data are made available to the mobile terminal, which otherwise it would have to receive over a longer period of time together with the satellite signals, and from which it would otherwise have to determine through iteration the position of the receivable satellites and eventually its own position. Combined with the already advantageous time savings are significant energy savings, which are especially important for mobile terminals.

In some implementations that mobile terminal is designed to provide information data in the network only when specific criteria are fulfilled, which may be obtained from one of the following parameters or a combination of the following parameters:
release or permission by the user to allow an information data set to be supplied,
geographic position of the mobile terminal,
number of satellites, from which the mobile terminal has received satellite signals,
reception quality of the satellite signals received by the mobile terminal,
age of the received information data set received by the mobile terminal,
type of mobile terminal,
type of the antenna of the mobile terminal.
request for information data by the base station or another mobile terminal, and/or
conditions attached to the base station request or the other mobile terminal have been met.

Such implementations have the advantage that the data traffic is kept low, and therefore the cost and energy consumption of the mobile terminals is reduced. In addition, this design can be compliant with the data security provisions that may have to be observed. Finally, this design allows the individual user to decide to supply other users with information data in return for the support received in the form of positioning data.

In some implementations a mobile terminal can request a positioning data set in the network when the mobile terminal has not received any data for a specific period of time, and/or stored data have reached the expiration date, and/or specific stored data have changed since the last satellite reception (e.g., the “mobile country code” has changed), and/or the user manually requests at least one positioning data set.

This means on one hand that the mobile terminal can determine its position very quickly, and on the other hand that the required exchange of data is kept to a minimum, saving money and energy. In addition, the mobile terminal can be automatically updated, so that a position can be determined even if no wireless network is available or assistant data cannot be obtained for other reasons.

In some implementations a mobile terminal can include an operating element whose operation directly and without additional operating steps by the user causes a positioning data set to be requested.

This provides special operating comfort. A user will also be able, e.g., in emergencies, to determine a position quickly and easily, and to provide rescue personnel with positioning information, if necessary.

In some implementations a mobile terminal can not only to supply raw satellite data in an information data set, but also to process the data in conjunction with additional data.

Such a mobile terminal can also to supply a base station with assistant data sets, which it has received from another network.

This has the advantage that with the help of data which otherwise are not easily accessible, previously stored data of other mobile terminals from one specific area can be augmented. Stationary reference stations are usually positioned to ensure optimum reception from as many satellites as possible. Mobile wireless network operators usually also provide reference data that are already mapped to the respective location of the receiver.

Some implementations provide a satellite data receiver with an antenna and an interface for communication with a mobile terminal, for example, a cable connection, a bluetooth or WLAN interface, which itself does not have any means of communication with the base station, but which is able to establish communication with the base station through its interface to the mobile terminal and its communications means. The satellite data receiver is designed so that it, together with this communication facilitator, has the characteristics of a mobile terminal in the various implementations described in this specification.

An advantage of such implementations is that, e.g., the GPS receiver with a corresponding interface, which also has a memory and CPU unit, does not have to have wireless functionality, which means it can be manufactured at reduced cost. Such implementations can also be used with simpler types of mobile phones that do not have sufficient CPU power or not enough memory space to perform the operations of a mobile terminal. Finally, such implementations allow the power supplies for both devices to be kept separate, so that the use of the navigation function does not consume the energy of the phone or vice versa.

In some implementations include a network with a base station with a communication device and a minimum of two mobile terminals with communication and receiving capability for the reception of satellite signals, with which the geographic position of the receiver can be determined. The mobile terminals will use the communication device and the communication medium to exchange data with the base station (unidirectional, bi-directional, multidirectional), so that at least one mobile terminal functioning as a reference unit is able to supply an information data set containing satellite signals or data derived therefrom within the network, and so that at least one mobile terminal functioning as a target unit in the network is supplied with a positioning data set, which at a minimum is based on the an information data set and which is designed for the target unit to be able to analyze the data received from the satellite based on this positioning data set.

In some implementations, an information data set is supplied to a target unit in the form of positioning data without any changes.

In some implementations, an information data set made available within the network is processed, and the processed data can be made available to a target unit as a positioning data set.

In some implementations, depending on at least one criterion, information data are supplied to a target unit unchanged in the form of a positioning data set, or one or several sets of information data are further processed. The data in its processed form is supplied as positioning data. The respective criteria can be based on one or more of the following parameters:
information data set containing raw data from the satellite signals,
information data set containing satellite data having been specifically processed in, e.g., the reference unit,
geographic position of the antenna of the reference unit,
geographic location of the antenna of the target unit to which the positioning data set will be supplied,
number of satellites, from which the reference unit has received satellite signals,
identities of the individual satellites, from which the reference unit has received satellite signals,
reception quality of the satellite signals of the individual satellites received by the reference unit,
age of the received information data set,
type of reference unit, and/or
type of the antenna of the reference unit.

Such a network can be designed for a large number of information data sets and/or positioning data sets to be stored by different reference units for different target units.

Such a network can be designed so that the geographic location of the receiver of the target unit can be predetermined, in the absence of any previous satellite signal reception by the target unit, from data which are made available by the target unit in the network, especially based on data allowing mapping based on one of the following options:
mapping to a geographic location based on IDs being transmitted and/or exchanged between a target unit and the network over a wireless, telephone, or data connection, e.g., the “Mobile Country Code”, and/or the “Mobile Network Code” and/or the “Location Area Code”
mapping to a geographic location based on service provider-specific information, e.g., the cell ID,
mapping to a geographic location based on an entered target address or the target coordinates,
mapping to a geographic location based on a position entered by the user, and/or
mapping to a geographic location based on the reception of signals that can be matched to a geographic position, e.g., IDs of local wireless networks, e.g., WLAN, Bluetooth, Near-Field, RFID and/or RDS IDs.

Such network is advantageously designed for a target unit to be notified in conjunction with a positioning data set if and/or under which conditions the target unit after having received the satellite signals shall serve as a reference unit and supply its own, new set of information. The conditions can be selected depending on the data stored inside the network, and especially in reference to the number of satellites received by the receiver of the target unit or the reception quality of the satellites received by the receiver.

Some implementations provide a method using a base station with a communication device for a network with mobile terminals, e.g., mobile telephones or vehicle navigation systems, with a reference unit for the reception of satellite signals, which can be used to determine the geographic position of the receiver. In some implementations, the method includes the following actions:
establishment of a first data connection with a mobile terminal functioning as reference unit,
reception of an information data set from the mobile terminal containing satellite signals or data derived therefrom,
establishment of a second data connection with a mobile terminal functioning as a target unit, and
supply of the target unit with a positioning data set based on one or multiple sets of information data designed in such fashion that the target unit is able to analyze data received from satellites based on the supplied positioning data.

In some implementations, the method includes the following additional actions:
determination of the geographic area, in which the target unit is located,
selection of one or multiple information data sets, whose (one or more) components under consideration of the geographic location of the target unit are appropriate as positioning data for the target unit.
decision if a single selected set of information data is suitable to be made available without changes as positioning data set, and supply of the unchanged information data set as positioning data set, or
further processing of components of one or multiple information data sets into a positioning data set, and the making available of this positioning data set, so the selection, decision and further processing will occur based on specific criteria, and the respective criteria can be obtained particularly based on one or more of the following parameters:
   information data set containing raw data from the satellite signals,
   information data set containing data from the satellite signals specifically processed, e.g., in the reference unit,
   geographic position of the receiver of the reference unit,
   geographic location of the receiver of the target unit to which the positioning data set will be supplied,
   number of satellites from which the reference unit has received satellite signals,
   identities of the individual satellites from which the reference unit has received satellite signals,
   reception quality of the satellite signals of the individual satellites received by the reference unit,
   age of the received information data set,
   type of reference unit, and/or
   type of the antenna of the reference unit.

With such method, the geographic location of the target unit's antenna can be determined based on data transmitted by the target unit to the base station without previous reception of satellite signals by the target unit, in particular of data allowing location mapping based on one of the following options:
mapping to a geographic location based on IDs being transmitted and/or exchanged between a target unit and the base station, e.g., the “Mobile Country Code”, and/or the “Mobile Network Code” and/or the “Location Area Code”
mapping to a geographic location based on service provider-specific information, e.g., a cell ID,
mapping to a geographic location based on an entered target address or the target coordinates,
mapping to a geographic location based on a position entered by the user, and/or
mapping to a geographic location based on the reception of signals that can be matched to a geographic position like e.g., ID's of local wireless networks, e.g., WLAN, Bluetooth, Near-Field, RFID or RDS IDs.

In some implementations, the method includes the following additional actions:
Notification of a mobile terminal if and/or under what conditions the mobile terminal will serve as a reference unit and provide a set of information data, so the conditions can be selected based on the satellite data already stored in the base station and which in particular may be able to reference the number of satellites received by the receiver of the target unit or the quality of the reception, with which the satellites are received by the receiver.

Some implementations provide a method for use with a mobile terminal, e.g., a mobile telephone or vehicle navigation system, using a satellite positioning system antenna for the reception of satellite signals, which can be used to determine the geographic position of the antenna, including the following steps:
reception of satellite signals,
establishment of a data connection to the base station and/or another mobile terminal,
supply of an information data set containing at least parts of the received satellite signals or data derived therefrom, based on which optionally with the addition of other information data sets of other mobile terminals a positioning data set can be generated, which is laid out for a target unit to be able to analyze the data received from satellites based on the positioning data.

In some implementations, the method includes the following additional actions:
establishment of a data connection to a base station and/or another mobile terminal,
sending of a request within a network for positioning data to be supplied,
reception of a positioning data set, and
analysis of satellite data based on the positioning data set.

In some implementations, the method includes the following additional actions:
checking after receipt of a positioning data set if a request to supply an information data set was received together with the positioning data set, and if specific criteria are associated with this request, if necessary
checking, if the criteria associated with the request were fulfilled, and
supply of an information data set when no request was received together with the positioning data set or the criteria for the supply are fulfilled, whereby compliance with the criteria can be obtained particularly from one or more of the following parameters:
   release/permission by user to allow information data to be supplied,
   geographic position of the mobile terminal,
   number of satellites, from which the mobile terminal has received satellite signals,
   reception quality of the satellite signals received by the mobile terminal,
   age of the received information data set received by the mobile terminal,
   type of mobile terminal,
   type of the antenna of the mobile terminal,
   request for information data by the base station or another mobile terminal, and/or
   conditions attached to the request by the base station or the other mobile terminal have been met.

In some implementations, the method includes the following additional actions:
Checking if a positioning data set or a set of similar data is stored in the mobile terminal, which enables the mobile terminal to analyze satellite data, and
Request for positioning data within the network, if none such data are stored.

During such a method, the test optionally focuses on the age or the storage date of a stored positioning data set, and a positioning data set is requested only if the storage date is passed a specific time or the age exceeds a specific age.

In such method, the test optionally focuses on an expiration date that is stored together with a positioning data set.

In such method, a positioning data set is optionally requested in the network when a user operates a specific operating element, e.g., a button.

Optionally, with such a method, the received satellite signals are, prior to being made available in the network, processed within the mobile terminal, particularly in conjunction with additional data, and then made available as an information data set in this processed form.

In some implementations, the method includes the following additional actions:
receipt of assistant data sets from another network,
supply of assistant data sets as positioning data sets.

Some implementations provide a method for use in a network consisting of at least one base station and at least two mobile terminals, e.g., mobile phones or vehicle navigation systems, with a reference unit for the reception of satellite signals. The method can be used to determine the geographic position of the reference unit, where one of the methods describe above is applied.

Other aspects of the invention relate to technologies for indicating status information of the GPS receiver, in particular, the battery status. These aspects are in particular directed to the communication between a satellite data receiving device and a display unit device.

Examples of units according to the above mentioned aspects of the invention may include such a satellite data receiving device (e.g., a so called GPS mouse) and such a display unit device (e.g., a mobile phone) which may communicate using an interface such as Bluetooth or the like.

Further aspects relate to communication, in particular, to transmitting status information from the satellite data receiving device to the display unit device in order to display the status of the satellite data receiving device on the display of the display unit device.

In some implementations, a method for indicating a battery status of a satellite data receiving device by means of a display unit device includes the actions of receiving satellite data by the satellite data receiving device, determining battery status information indicating the battery status of the battery powering the data receiving device, and creating a data set having a plurality of data fields corresponding to a common data set standard based on the received satellite data and the battery status information, wherein at least one data field of the created data set, which is not read by the display unit device for navigation purposes, contains data based on the determined battery status information.

In some implementations, the data set is a GPRMC (GP: sender identifier (GPS receiver), RMC: recommended minimum sentence C, that is a recommendation for the minimum a GPS receiver should dump) sentence created substantially conforming with the NMEA (National Marine Electronics Association) 0183 protocol and the data field of the GPRMC sentence that is not read by the display unit device for navigation purposes and contains data based on the determined battery status information is the data field of the GPRMC sentence reserved for information about the magnetic declination information.

In some implementations, apparatus in accordance with this aspect includes a satellite data receiving device having an antenna operable to receive satellite data, a battery charge controller operable to determine battery status information reflecting the battery status of the battery powering the data receiving device, and a data processing device operable to create a data set comprising a plurality of data fields corresponding to a common data set standard based on the received satellite data and the battery status information, wherein at least one data field of the created data set is not read by the display unit device for navigation purposes, and contains data based on the determined battery status information.

The other aspect regarding the communication relates to transmitting instructions in order to control status displays of the satellite data receiving device.

In some implementations, a method for controlling the brightness of a light emitting device, e.g., a light emitting diode (“LED”) of a satellite data receiving device indicating status information includes the actions of providing a satellite data receiving device having at least one controllable light emitting device, providing a display unit device having a sensor operable to determine ambient information determining ambient information by means of the sensor, creating a proprietary data set based on the ambient information, transmitting the proprietary data set to the satellite data receiving device, and controlling the light emitting device of the satellite data receiving device based on the information contained in the data set. Proprietary in this sense means that any data set can be used and no specific standards or protocols have to be used. However, in some implementations, respective information is appended to other data or amends other data, respectively.

In some implementations, this can be a method for adjusting the brightness of a light emitting device of a satellite data receiving device indicating status information, in which the sensor is a light sensor that determines the ambient brightness, the light emission of the light emitting device is controlled to a low level when the ambient brightness is low, and the light emission of the light emitting device is controlled to a higher level when the ambient brightness is higher.

Particular implementations of these aspects have the advantage that the satellite data receiving device does not need to be equipped with components that are part of the display unit device. Moreover, a user can be provided with status information even if he can only perceive information from the display unit device, e.g., when the satellite data receiving device is separated from the display unit device.

The details of one or more embodiments of the subject matter described in this specification are set forth in the accompanying drawing and the description below. Other features, aspects, and advantages of the subject matter will become apparent from the description, the drawing, and the claims.

### BRIEF DESCRIPTION OF THE DRAWING

FIG. 1 shows a schematic view of a network according to a preferred embodiment with a base station, a mobile terminal serving as a reference unit, and a mobile terminal serving as a target unit and a communication device.

### DETAILED DESCRIPTION

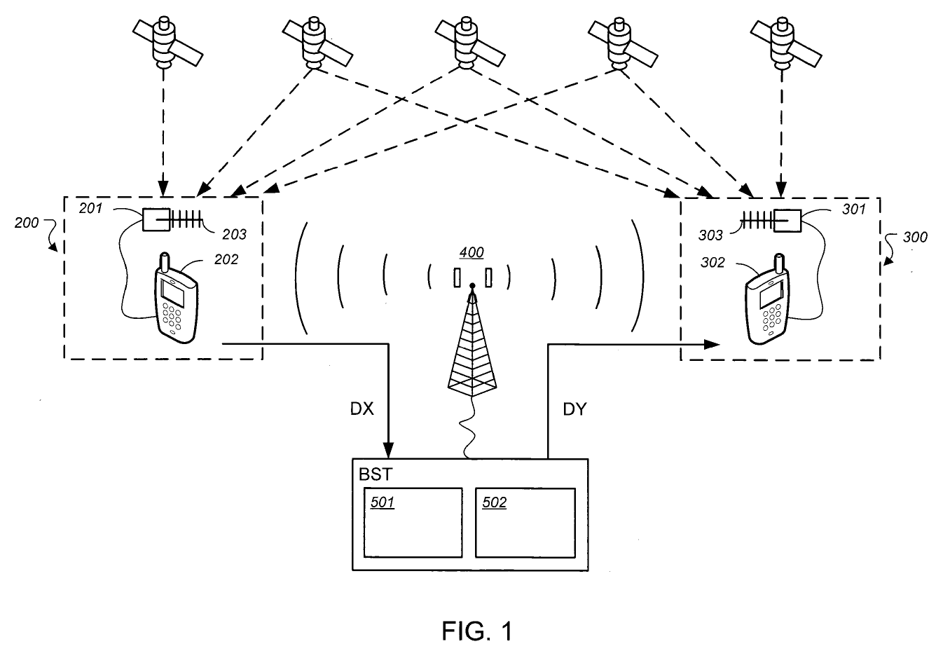

FIG. 1 shows an illustrative network with a base station BST, a mobile terminal as reference unit 200, a mobile terminal as target unit 300, and communication device 400. However, there may be multiple mobile terminals as reference units and/or multiple mobile terminals as target units, and individual or all mobile terminals may serve as reference units as well as target units. Also shown in FIG. 1 are satellites 101, 102, 103, 104, 105. A geographic position (i.e., location, altitude, and optionally a moving direction and/or moving speed) of at least the mobile terminal as target unit 300 with the help of a positioning data set DY can be determined.

A base station generally includes a central processing unit 501, and at least one storage unit 502, and depending on the situation, may function as server or client. A communication device 400 of the base station BST includes a connection connecting the base station BST to a mobile wireless network, which can be used by a large number of mobile terminals. Connections to other wireless networks can also be implemented, e.g., connections to deep-sea vessels or to mobile devices in areas where no mobile wireless networks are available. The base station BST itself can be connected over the Internet, over direct data lines or over wireless networks to the telephone or data networks of one or multiple mobile wireless providers, so that the base station BST can establish connections to mobile terminals in different telephone and/or other wireless networks. In other words, unidirectional, bi-directional or multidirectional connections or data exchange between the base station BST and the mobile terminals are possible.

Mobile terminals can be mobile telephones 202, 302 with at least one (internal or external) satellite positioning system receiver 201, 301, e.g., a GPS-receiver, each with at least one corresponding antenna 203, 303, but may also be navigation systems in vehicles, on ships or in aircraft. The antennas can be any kinds of antennas suitable for receiving signals transmitted by satellite positioning system satellites. The satellite positioning system receivers 201, 301 and the reference unit 203, 303 are suited to receive satellite signals transmitted by one or multiple satellites 101-105, which are part of a satellite system (or multiple satellite systems) to determine a location, e.g., NAVSTAR-GPS satellites. Mobile terminals that want to use the satellite signals of satellite positioning system satellites for private purposes must be able to receive the satellite signals.

GPS satellites have two transmitters, which operate with spread-spectrum technology, and which transmit on the GPS frequencies of 1.57542 GHz (so-called L1-frequency) and 1.2276 GHz (so-called L2-frequency). The L2-frequency is used mostly to send the encrypted P/Y-Code (“precision-encrypted”) for military use. The P/Y code is also transmitted via the L1 frequency.

The L1-frequency also transports the C/A code (“Coarse/Acquisition”) for commercial use and a navigation message.

The transmitted C/A code is a pseudo-random, 1023 bit long code, which is unique for every satellite. The C/A code is broadcast with 1.023 MHz, i.e., 1,000 times per second. Due to this “pseudo-random noise” (PRN) these signals are less susceptible to interference and all satellites can transmit with the same or a very close frequency.

The navigation message has a data frame, which has in particular 25 data packets (“frames”), which have 5 subframes. Every subframe has 10 data words, which each include 30 bits. The navigation message is transmitted at a data transmission rate of about 50 bits/sec. Accordingly, one data word requires 0.6 seconds for the transmission. The resulting length of a subframe is 300 bits and a transmission period of about 6 seconds as well as a frame of 1,500 bits and about 30 seconds. The entire GPS-signal includes in particular 37,500 bits and requires a transmission time of about 12.5 minutes.

The first three subframes of each of the 25 frames include for each satellite the parameters of the ephemeredes (ecliptic data), information about the actuality of the ephemeredes and clock correction values. Since the first three subframes are the same for every satellite, the most important positioning data are sent every 30 seconds.

For the initialization of devices, the so-called “almanac” is also preferentially transmitted. Each of the 24 satellites of the GPS-system sends the almanac data of all satellites distributed across subframes 4 and 5 of all frames. The almanac data contains in particular information about the ecliptic parameters of all satellites, their technical condition, identification numbers, etc. From the almanac data the receiver 201, 301 can see and/or deduce which satellites are likely to be in its line of sight, and so can limit its search to these satellites. The transmission of the almanac requires approximately twelve minutes.

In the frequency ranges being used, the electromagnetic radiation propagates like visible light almost in a straight line but is very little affected by the weather (clouds, precipitation). Therefore, and due to the low transmission power of the GPS-satellites, the best reception of the signals requires a direct line of sight to the satellites. In buildings, tunnels, underground parking garages, etc., GPS-reception was not possible until recently. Also, between high buildings, inaccuracies may be generated by multiple signal reflections (multipath effect). In addition, large inaccuracies are generated partially in unfavorable satellite constellations, e.g., when only three satellites close to each other in one direction are available to determine the position.

Currently, the following two service classes are available: SPS (Standard Positioning Service) is available to everyone and originally achieved an accuracy of about 100 m (in 95% of the measurements). In May 2000 the artificial inaccuracy was switched off by the military; since then the accuracy is about 15 m. PPS (Precise Positioning Service) is reserved for military use and is originally laid out for an accuracy of about 22 m (in 95% of the measurements); the current accuracy is not known. The signals for PPS are broadcast in encrypted form.

An advantageous design of a mobile terminal 200, 300, which is able to supply the base station BST with an information data set DX, can be created in such fashion that the mobile terminal 200, 300 has a memory, in which the data are stored, which are received from one or multiple satellites 101-105, and a central processing unit, which processes and analyzes the received data. The analyzed or processed data can then be stored again. The stored data—which may be raw data received in the form of satellite signals, or analyzed or processed data—can be read by the mobile terminal 200, 300 from the memory and made available through a communication device 202, 302 to the base station BST as information data set DX, for example.

An information data set DX generally contains at least components of almanac data, ephemeris data or identification data for individual satellites 101-105 from which signals have been received. Furthermore, an information data set DX generally contains information about the geographical position of the satellite receiver 201, 301 and its antenna 203, 303, information about the reception quality of the satellite signals from individual satellites 101-105, or time references. If a reference unit has received the total (typically 25 frames) navigation message, it can make any data included in the navigation message available within the scope of an information data set DX. Especially the subframes 1-3 of a frame (for different satellites 101-105) and the subframes 4 and 5 of all frames are of interest. However, it is equally possible that only information in regard to individual satellites 101-105 is made available.

The communication devices 202, 302 of the mobile terminals 200, 300 make it possible to establish a connection to a base station BST through its communication device 400, and to send or exchange data DX. Such communication devices 202, 302, e.g., mobile wireless receivers or transmitters, allow the exchange of data over the mobile wireless network through a mobile terminal 200, 300. The following mobile wireless-specific data protocols can be used: “wireless application protocol” (WAP), “general packet radio service” (GPRS), “circuit switched data” (CSD), “high speed circuit switched data” (HSCSD), SMS, UMTS, CDMA, WCDMA, or other standards. Communication devices can also be WLAN or bluetooth units that enable a mobile terminal 200, 300 to communicate via WLAN and/or bluetooth with a base station or other mobile terminals 200, 300.

As is shown, data can be transmitted using different protocols. Data connections allowing the fast transmission of data (preferably at a minimum of 10 kbits/sec) may be desired. Among multiple available data transmission paths, such paths may desired which for the intended purpose and/or data volume cause the least cost. There are different calculation methods, with some of them generating costs per data packet with a specific size, per time unit for which a data connections is present, or per volume of data. Should multiple data transmission paths between the base station and an individual mobile terminal 200, 300 be available, then the base station can optionally be implemented to operate in such manner that in the individual case it will select a variation especially suited to these aspects.

The receivers 201, 301 of the mobile terminals 200, 300 preferably include antennas 203, 303 suited to receive satellite signals. For the time being, it is only possible to determine the position of the antenna 203, 303, which is not necessarily identical to the position of the receiver 201, 301.

In the illustration shown in FIG. 1, the reference unit 200 receives signals from four satellites 101, 102, 103, 104, and the target unit 300 also receives signals from four (partly different) satellites 102, 103, 104, 105. As noted earlier, for the GPS-system a total of 24 satellites are located on six orbits around the earth, presently (status of 2005) combined with spare satellites to make a total of 31 satellites. A satellite receiver 201, 301 with a good line of sight to the sky receives on average signals from eight satellites.

Due to interference from buildings, weather conditions or the location itself, it may be that, as shown in FIG. 1, fewer satellites 101-105 are visible and a mobile terminal 200, 300 that in principle can see five satellites may receive data from only four of them.

Depending on the type of device, after receiving the satellite data, the reference unit 200 may be able to process the received satellite data and/or to provide or communicate the satellite data in most part or to a large extent unchanged as information data DX to the base station BST.

The reference unit 200 in some implementations is able to analyze the received satellite data and determine its own position, and then supply or transmit the current ephemeredes of the individual satellites 101, 102, 103, 104 and/or additional information, e.g., the receiving time, receiving location and/or at least a part of the almanac data, in the network as information data set DX to the base station BST. Other components of an information data set DX have already been described above.

The base station BST in some implementations is able to recognize if the information data set DX contains one or more satellite signals that have not been further processed and are generally still in their raw form, or if the data have already been changed in the respective reference units 200. That means that the base station is able to detect and (further) process different formats of received information data sets DX. Depending on the type of the unit, the information data sets DX can initially be stored unchanged and processed further at a later point in time, optionally depending on data received by a target unit 300. In the same manner, the information data sets DX, after having been received, can immediately be analyzed, broken down into their components, and stored. Depending on the requirements, only individual components can be stored (e.g., ecliptic data of individual satellites), optionally with data referring to the time when the information data was received, the location of the antenna 203 at the time when the satellite data were received, and/or other data. Other components that are not required do not need to be stored. For example, current information about specific satellites might already be stored in a base station, so that only data about other satellites are required from an information data set DX.

Certain data cease to be current after some time or cannot be used anymore after a certain (e.g., predetermined) time, so that data for specific satellites should be replaced by more recent data, and data for other satellites may be maintained under certain conditions, even if they have reached a certain age, e.g., because they have not received any newer data yet. The decision of whether and how a data set is stored can also be affected by which receiver 201 the data set is stored. For example, some old receivers 201 are less sensitive, so that data from satellite, which are barely received by these devices, are easily received by other receivers 201.

In the illustrative example, the target unit 300 can be supplied with positioning data (e.g., the ephemerid data) for the satellites 101, 102, 103, 104, and in addition other positioning data (e.g., ephemerid data) from satellite 105, if they are already stored or available in the base station BST. Should DY the target unit 300 already be notified which satellites 102-105 are currently in its window of sight, then in conjunction with a request of a positioning data set, the positioning data can be limited to three satellites 102, 103, 104 that are located inside this window of sight. In addition or alternatively, at least a part of the almanac data regarding other satellites 102-105 actually or potentially located in the field of sight can also be supplied or transmitted to the target unit 300.

Independent of the question how the data, which were received as part of the information data set DX, are being stored, the composition of the positioning data sets DY being supplied or transmitted to the target unit 300 can also be made contingent on specific criteria.

For example, the target unit 300 may, together with a request for a positioning data set DY, transmit specific additional data. Such data may contain information about the geographical location of an antenna 303; and in the base station BST, data can be selected that originate from reference units 200 which were located close to the area from which the request of the target unit 300 originated. The distance is preferably less than 200 km, even more preferably, less than about 100 km, and most preferably, less than 10 km from the receiver 300.

On the other hand, for example, based on earlier requests by the target unit 300 or due to individual data that are stored for a specific user, it may be determined which target 300 must be supplied with a positioning data set DY, and what the technical configuration of the target system or target unit 300 is, so that it is known, for example, which reception quality can be achieved for the receiver 301 or the receiver 303, and if the target unit 300 has sufficient CPU power and memory space. Such data may also be transmitted by the target unit 300 together with the request for a positioning data set DY to the base station BST.

Furthermore, it is possible, if it has been detected that the reception quality of the receiver 301 or the antenna 303 of the target unit 300 is continuously bad, not to transmit data for specific satellites 102-105, for which it is known that they are difficult to receive in the target area. It is also possible, if it is known that the target unit 300 has only limited memory space, to supply the target unit with data only for satellites that are in the reception area at that time, i.e., that are “visible” to the target unit 300, and not to send any data for later use.

It is also possible to supply a largely unchanged information data set DX if it is known that the target unit 300 is located close the reference unit 200 (as described above), and if the information data set DX from the reference unit 200 was received just a short time ago.

As already shown, it is possible based on knowledge about the exact or approximate location of a target unit 300 to select or supply the appropriate or selected data for the respective target unit 300. Especially advantageous for this purpose are data that the mobile wireless operator can obtain from the so-called cell ID. However, this information is usually only available to the respective network operators, so that these data cannot always be used by third parties.

An approximate determination of the location can also be obtained with the following other methods, which in individual cases may be advantageous. For example, together with a connection to a mobile telephone, the so-called “Mobile Country Code”, the “Mobile Network Code” and/or the “Location Area Code” are also transmitted. From those generally available codes, the location can be limited from a country to a specific region, and at least within an area of some 100 kilometers.

More accurate data can be determined from a position and/or a navigation target entered by the user, e.g., manually, at least if the navigation target is not also located at a distance of some 100 kilometers from the location of the target unit 300. The location be determined even more exactly if it is known to the user, and the user enters this position manually.

Another option to determine a location results from the reception of signals that can be matched to a geographical location. An example of such signals are the IDs of wireless networks that are available locally only. The IDs of WLAN (wireless local area network) or bluetooth or Near-Field networks, RFID ID's or RDS signals can be used. The RDS (“Radio Data System”) ID is sent by many radio stations, and makes it possible to identify the respective radio station and display it to the listener. Sent together with the other RDS data is an internal identification code having a four-digit hex number which allows the approximate identification of the sender and therefore the sender region. Therefore, in an advantageous design of the mobile terminals 200, 300, such radio signals can be received by the mobile terminal 200, 300.

In some implementations, the devices (mobile terminals 200, 300, base station BST, etc.) are configured to operate so that the base station notifies an mobile terminal 200, 300 if and under what conditions the mobile terminal shall transmit an information data set DX to the base station. Such notification can take place together or in conjunction with the provision of a positioning data set DY, for example. An according request can also be sent independently of a positioning data set DY, for example, when a mobile terminal 200, 300 is already being used, and receives other data from the base station BST, e.g., direction or travel information about how a specific destination can be reached from the current position. The base station BST may request an information data set DX completely without a request by the mobile terminal 200, 300. Such a request could be related to the selection of data (e.g., for specific satellites), or could be made dependent on appropriate criteria, which have been mentioned earlier.

A mobile terminal 200, 300 in some implementations only provides an information data set DX if specific conditions are met. This makes it possible to provide mobile terminals 200, 300, for example, with which the user has the option of receiving positioning data sets DY without being obligated to supply an information data set DX. The release by the user could requested selectively, e.g., based on the layout of the mobile terminal 200, 300, in each individual case or generally for one part or generally for all cases.

The option for a user to receive positioning data sets DX can be made dependent on the agreement of the user to provide information data sets DX. This restriction can be deactivated for emergency calls, so that a user, who has not agreed to provide information data sets DX from his/her mobile terminal 200, 300 is able to receive positioning data sets DY, when they are requested in conjunction with an emergency call.

In some implementations, a mobile terminal 200, 300, provided certain conditions are met, can request a positioning data set DY. This may take place each time the mobile terminal 200, 300 attempts to determine its own position or only if no satellite signals have been received for certain time or the expiration data stored together with already store satellite data has been reached. It makes sense to request new satellite data when, based on certain data available or stored in the mobile terminal 200, 300, it becomes apparent that the location of the mobile terminal 200, 300 has changed to such extent that the available satellite date are not applicable any more due to the change of location. Such change of location may again result from the data mentioned above (cell ID, mobile country code, wireless IDs, etc.).

In some implementations, it is possible for a mobile terminal 300 to request a positioning data set DY when the user operates a specific operating element, for example, pushing a dedicated button associated with additional functions. For example, this button can be used to start a navigation program, which first determines the given geographic position and, if necessary, also requests a positioning data set DY, and which in the next operating step requires a destination address to be entered. Another example would be that the button can be pressed to initiate an emergency call system, so that together with the call the position of the caller or his/her mobile terminal is also transmitted to the rescue personnel.

In some implementations, the assistant data sets supplied by the mobile wireless operators to their customers that are based on satellite data received by stationary reference stations of the mobile wireless operators (e.g., as part of the A-GPS system) are made available in the network in addition to the positioning data DY by mobile reference units 200. For non-network operators, these data are usually not accessible through the telephone network; however, if they have been read by a user and stored on a mobile terminal 200, 300 with a GPS receiver 201, 301, this information can be read from the mobile terminal memory and made available in another network as part of an information data set DX. In other words, it is possible to combine or augment information data sets DX of mobile terminals 200, 300 being used as reference units 200 with assistant data from stationary reference stations, so that, e.g., depending on the quality, age, and/or number, of the respective data, the positioning data set DY includes parts of the information data set DX as well as assistant data.

In some implementations, a navigation system in a vehicle which does not have its own means of communication is able to communicate through an interface with a mobile phone 300, requesting the positioning data set DY over this mobile phone 300.

Alternatively or in addition, the positioning technologies described above can be used in combination with the generally known method of Differential Global Positioning System (DGPS). In the DGPS method, there is a receiver whose position is to be determined and which is called the “rover”, and at least one additional receiver whose position is known and which called the “supporting point”. A supporting point is able to determine diverse information about why the position determined by GPS is faulty, since its position is known. With this information (correction data) from a base or reference location, a rover can increase its accuracy. The achievable accuracy depends, among other things, on the distance between the rover and the supporting point.

In the simplest DGPS methods the supporting point transmits its positioning error to the rover. The rover corrects its position accordingly. This works especially when both receivers are analyzing signals from the same satellites (this is typically the case only across a short distance and/or in the same neighborhood).

In the method of pseudo range correction, the supporting point calculates the error of the distances to the satellites and transmits them to the rover. This allows a correction to be made when the supporting point and the rover each receive different satellites. Accuracies of under one meter are possible.

The correction data from a supporting point to the rover can be transmitted wirelessly. A rover is then immediately able to increase its accuracy. Corrections can also be made at later time, if the rover and supporting point record all data for the positioning.

The correction data can also be generated by a user (with a second GPS receiver) or can be obtained from a number of providers, e.g., ALF (Accurate Positioning by Low Frequency), AMDS (Amplitude-Modulated Data System), SAPOS (Satellite Positioning Service of the German State Survey), ascos (satellite positioning services of the E.ON Ruhrgas AG), WAAS (Wide Area Augmentation Service), and EGNOS (European Geostationary Navigation Overlay Service).

The following paragraphs of this specification describe systems that have a base station, one or multiple reference stations 200 and one or multiple mobile terminals 300 communicating over the Internet. A reference station can include a GPS receiver 201, e.g., a so called GPS mouse, connected wirelessly or electrically with a Bluetooth interface or an RSB232 interface or a USB (Universal Serial Bus) interface or the like to a processing device such as a mobile phone or the like. The processing device uses the SiRF binary protocol for communication, ephemerid poll commands and data transfer. The GPS receiver collects ephemerid data from GPS satellites and provides it to the processing device in binary format.

As an example, such a system with two reference stations, each collecting ephemerid data with a GPS receiver being connected to a mobile phone, will now be described:

The GPS receiver of reference station 1 (ref1) collects the following ephemerid data set and transmits it to the mobile phone:

A0A2005C0F050005007E90A65B900053932A8CC24B1FCAC31C
2AF7DB60AD0000922A964F0005007E9128DBFD48399CF9362D
FFFDA303CDA67C0E9BA10E53EC60AD300005007E91AEFFEE
714F9A1B003B263EE2561D252CBD448FFFA441DB025F25DEB
0B3

The format of the foregoing data set is as follows:
start sequence: a0 a2 (2 bytes)
payload length: 00 5c (2 bytes)
message id: 0f (1 byte)
contents: 05 00 . . . 02 5f (91 bytes)
checksum: 25 de (2 bytes)
end sequence: b0 b3 (2 bytes)

The GPS receiver of reference station 2 (ref2) collects the following ephemerid data set and transmits it to the mobile phone:

A0A2005C0F090009007E90A65B91015B932A8CC24B1FCAC31C
2AF43E60AE00000E047B4E0009007E91283EF9F232A1206C8800
FAD709690167113AA10CF3D360AE7E0009007E91AEFF7848772
982002E272F43111C6833E61BD0FFA51D3E06A9217AB0B3

The processing device within the mobile phone adds the name of the reference station to the collected ephemerid data and sends it in hex format (starting with ‘A0A2’ and ending with ‘B0B3’) to the server 501 of the base station using, e.g., an XML-based protocol like SOAP (Simple Object Access Protocol) or other protocol for exchanging data. The server 501 stores the received data of the reference stations into a storage unit 502.

The database entries of two reference stations (ref1 and ref2) in one implementation will now be described:

Database entry for reference station 1 (ref1):

| ID | NAME | ISO_COUNTRY_CODE | MESSAGE_DATE |
|---|---|---|---|
| 1 | ref1 | 276 | 2006- |
| | | | 8-31.14.33. 7. 713000000 |

A0A2005C0F050005007E90A65B900053932A8CC24B1FCAC31C
2AF7DB60AD0000922A964F0005007E9128DBFD48399CF9362D
FFFDA303CDA67C0E9BA10E53EC60AD300005007E91AEFFEE
714F9A1B003B263EE2561D252CBD448FFFA441DB025F25DEB
0B3

Database entry for reference station 2 (ref2):

| ID | NAME | ISO_COUNTRY_CODE | MESSAGE_DATE |
|---|---|---|---|
| 1 | ref2 | 276 | 2006- |
| | | | 8-31.12.51. 8. 304000000 |

A0A2005C0F090009007E90A65B91015B932A8CC24B1FCAC31C
2AF43E60AE00000E047B4E0009007E91283EF9F232A1206C8800
FAD709690167113AA10CF3D360AE7E0009007E91AEFF7848772
982002E272F43111C6833E61BD0FFA51D3E06A9217AB0B3

On the server 501, all ephemerid data from all the reference stations is merged, i.e., duplicate ephemerid data is not be stored, or if it is stored, it is then deleted. The server stores the ephemerid data of the satellites visible from the reference stations into the storage unit 502. A client in this system, e.g., a mobile terminal, includes a GPS receiver 301 and a mobile phone 302. A computer program which is, e.g., running on the mobile phone downloads the ephemerid data from the server 501 at startup and preloads the GPS receiver 301 connected to the mobile phone 302 with the ephemerid data, if necessary. Depending on the generation of the GPS receiver, preloading of the GPS receiver with ephemerid data is in general only necessary if there are, for example, less than four satellites.

If preloading is necessary the procedure at the mobile terminal in this case can be as follows:
1. Download of ephemerid data from server 501 (byte-array consisting of x*91 bytes data (=message id+contents)
2. warm start of GPS receiver 301 with $PSRF104,0.0,0.0,0,0,0,0,12,2*13
3. switch GPS receiver 301 to binary mode with $PSRF100,0,57600,8,1,0*37
4. send ephemerid data to GPS receiver 301 with the following message:
   start sequence: a0 a2 (2 bytes)
   payload length: 00 5b (2 bytes)
   message id: 95 (1 byte)
   contents: 00 08 . . . 0a ft (90 bytes)
   checksum: 2b 49 (2 bytes)
   end sequence: b0 b3 (2 bytes)

### EXAMPLE

a0 a2 00 5b 95 00 08 00 96 00 a4 5b 90 00 73 c1 8e 47 86 36
fd ea d1 28 07 f8 ea 72 42 00 ff f4 f5 c3 ae 00 08 00 96 01 2a
ea f7 61 2c be da 1e 67 7c f8 28 05 06 47 61 10 5b a1 0c d3 28
72 42 7c 00 08 00 96 01 ac ff cd 4b bc 1b ff ff b9 27 b0 a8 c1
1d ad 6c f1 99 d1 ff aa b8 ea 0a f0 2b49 b0 b3 . . . a0 a2 00 5b
95 00 0a 00 96 00 a4 5b 91 01 7b c1 8e 47 86 36 fd ea d1 2807
fb 21 72 42 00 00 05 0b a9 f2 00 0a 00 96 01 2a 21 06 e6 2f b6
5d 556e 94 05 fe 03 9d d0 ec 09 bd a1 0d 6e 2a 72 42 7d 00 0a
00 96 01 ac ff 96 f5 98 ad e5 00 04 27 a3 a1 ba 25 22 11 dc de
be ff a8 63 21 00 ad 24 d4 b0 b3

5. switch GPS receiver 301 to NMEA mode (i.e., binary mode off) with:

a0 a2 00 18 81 02 01 01 00 01 00 01 00 01 01 01 00 01 00 01
00 01 00 0100 01 e1 00 01 70 b0 b3

The GPS receiver 301 now collects satellite data and provides it to the mobile phone.

Some implementations provide an indication of a ‘battery low’ condition of a GPS receiver to a connected accessory device (e.g., a navigation device) and enable the accessory device to adjust the light intensity of light emitting devices of the GPS receiver connected to the accessory device.

A ‘battery low’ condition of a GPS receiver can be indicated to a connected accessory device (1) with a special usage of the RMC sentence (GPRMC) of the NMEA message or (2) with a special purpose message.

In some implementations, a special usage of the RMC sentence (GPRMC) of the NMEA message for indicating ‘battery low’ of a GPS receiver uses the ‘Magnetic Variation’ field which is not supported (i.e., not used) by SiRF. The ‘East/West Indicator’ field is also not used by SiRF and could also be used. Either SiRF NMEA messages, SiRF binary formats, or messages and formats of other companies or GPS chipsets (e.g., power management integrated circuit connected with GPIO (General Purpose Input/Output) of SiRF chipset) can be used.

The format of a RMC message is as follows:

$GPRMC,<UTC Time>,<Status>,<Latitude>,<N/S
Indicator>,<Longitude>,<E/W Indicator>,<Speed Over
Ground>,<Course over Ground>,<Date>,<Magnetic
Variation>,<East/West Indicator>,<Mode>,<Checksum>

An example of a message carrying a batter low indication is as follows:

$GPRMC,112057.000,A,4807.0497,N,01135.8431,E,0.51,252.48,29
0606,1,,A*CKSUM

An example of a message carrying a batter ok indication is as follows:

$GPRMC,112057.000,A,4807.0497,N,01135.8431,E,0.51,252.48,29
0606,0,,A*CKSUM

An example of a format of a special purpose message for indicating ‘battery low’ condition of a GPS receiver is as follows:
<Message ID>,<Percent>,<Status>,<Remaining Time>,<Checksum>

### In this example, <Percent> indicates the ‘battery loading level’, <Status> indicates the battery states ‘loaded’, ‘loading’ or ‘empty’ and the <Remaining Time> indicates the ‘remaining operation time’ of the GPS receiver.

An example of a message (battery is at 27%, battery is loading and battery will remain operable for 90 minutes) in this format is as follows:
$BAT,27,1,90*CKSUM

Some implementations provide a feature that the light intensity of light emitting devices of a GPS receiver can be adjusted by the accessory device with a proprietary message (e.g., navigation device with ‘night mode’ dims the LEDs, for example, of a connected GPS receiver). In this context, a proprietary message is one that includes features that do not emanate from a standards organization.

In some implementations, the proprietary message has the following format:
<Message ID>,<Intensity>,<Checksum>

### In this format, <Intensity> indicates the intensity of the LED's (from 0% to 100%).

An example of a message (LED is illuminated with intensity of 35%) in this format is as follows:
$LED,35*CKSUM

Embodiments of aspects the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on an information carrier medium for execution by, or to control the operation of, data processing apparatus.

The term “data processing apparatus” encompasses all apparatus, devices, and machines for processing data, including by way of example a programmable processor (also know as a CPU (central processing unit)), a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer-readable medium can be a machine-readable storage device, a machine-readable storage substrate, a memory device, or a combination of one or more of them. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

An information carrier medium can be a propagated signal or a computer-readable medium. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results.

What is claimed is:

1. A method for indicating a battery status of a satellite data receiving device by means of a display unit device, the method comprising:
receiving satellite data by the satellite data receiving device;
determining battery status information indicating the battery status of the battery powering the data receiving device; and
creating a data set comprising a plurality of data fields corresponding to a common data set standard based on the received satellite data and the battery status information;
wherein at least one data field of the created data set which is not read by the display unit device for navigation purposes, contains data based on the determined battery status information.

2. The method of claim 1, wherein:
the data set is a GPRMC sentence substantially conforming with a NMEA 0183 protocol; and
the data field of the GPRMC sentence which is not read by the display unit device for navigation purposes and contains data based on the determined battery status information is a data field of the GPRMC sentence reserved for magnetic declination information.

3. A satellite data receiving device comprising:
an antenna operable to receive satellite data;
a battery charge controller operable to determine battery status information reflecting the battery status of the battery powering the data receiving device; and
a data processing device operable to create a data set comprising a plurality of data fields corresponding to a common data set standard based on the received satellite data and the battery status information;
wherein at least one data field of the created data set which is not read by the display unit device for navigation purposes, contains data based on the determined battery status information.

4. A method for controlling the brightness of a controllable light emitting device of a satellite data receiving device indicating status information, the method comprising:
determining ambient information by means of a sensor operable to determine ambient information, the sensor being part of a display unit device;
creating a proprietary data set based on the ambient information;
transmitting the proprietary data set to the satellite data receiving device; and
controlling the light emitting device of the satellite data receiving device based on the information contained in the data set.

5. The method of claim 4, wherein:
the sensor is a light sensor operable to determine the ambient brightness and the light emission of the light emitting device is controlled to a low level in case the ambient brightness is low; and
the light emission of the light emitting device is controlled to a higher level in case the ambient brightness is higher.
